(19) United States
(12) Patent Application Publication
(10) Pub. No.: US 2026/0141087 A1
(43) Pub. Date: May 21, 2026

(54) ELECTRONIC SIGNATURE SYSTEM AND AN OPERATION METHOD OF SIGNING DEVICE INCLUDED THEREIN

(71) Applicant: Samsung Electronics Co., Ltd., Suwon-si (KR)

(72) Inventors: Won Hee Cho, Suwon-si (KR); Mungyu Bae, Suwon-si (KR); Jisoo Kim, Suwon-si (KR); Yongjae Lee, Suwon-si (KR); Younsung Chu, Suwon-si (KR)

(21) Appl. No.: 19/237,307

(22) Filed: Jun. 13, 2025

(30) Foreign Application Priority Data
Nov. 15, 2024 (KR) 10-2024-0162872

(51) Int. Cl. G06F 21/60

(52) U.S. Cl. CPC G06F 21/602

(57) ABSTRACT

An example electronic signature system may comprise: a secret key management device configured to output a Merkle tree generated based on a plurality of secret keys and to output a base signature generated based on a target secret key which is one of the plurality of secret keys; and a signing device configured to generate an electronic signature corresponding to the target secret key based on the Merkle tree and the base signature.

### CROSS-REFERENCE TO RELATED APPLICATION

This application claims priority to and the benefit of Korean Patent Application No. 10-2024-0162872 filed with the Korean Intellectual Property Office on Nov. 15, 2024, the entire content of which is incorporated herein by reference.

### BACKGROUND

Electronic signature systems are widely used in information security technology to verify forgery or tampering of data. An electronic signature system may include a signing device and a verification device. The signing device may generate an electronic signature to be transmitted along with a message. The verification device may store a verification key. The verification device may determine whether a message was provided by an authorized signing device by verifying the electronic signature based on the verification key.

The electronic signature may be generated based on a Merkle tree structure based on a plurality of secret keys. In this case, the number of verification keys should be stored in the verification device for verifying the electronic signature may be minimized, but a time taken by the signing device to generate the electronic signature may increase excessively depending on the depth of the Merkle tree.

### SUMMARY

The present disclosure relates to an electronic signature system generating an electronic signature with faster speed and an operating method of a signing device included therein.

In general, according to some aspects, an electronic signature system may comprise a secret key management device configured to output a Merkle tree generated based on a plurality of secret keys and to output a base signature generated based on a target secret key which is one of the plurality of secret keys; and a signing device configured to generate an electronic signature corresponding to the target secret key based on the Merkle tree and the base signature.

In general, according to some aspects, an electronic signature system may comprise: a secret key management device including a secret key memory circuit configured to manage first to 2^{k}-th secret keys, and a Merkle tree generation circuit configured to generate a Merkle tree based on the first to 2^{k}-th secret keys (wherein the ‘k’ is an integer greater than or equal to 1); a signing device including a tree memory circuit configured to store an upper Merkle tree which is a part of the Merkle tree in a verification preparation stage, and a signature generation circuit configured to generate a first electronic signature based on the upper Merkle tree in a first signing stage after the verification preparation stage; and a verification device configured to verify the first electronic signature in the first signing stage.

In general, according to some aspects, an operation method of a signing device may comprise: receiving, from a first external device, a Merkle tree generated based on a plurality of secret keys; generating a message; receiving, from the first external device, a base signature generated based on the message and a target secret key, which is one of the plurality of secret keys; generating an electronic signature based on the Merkle tree and the base signature; and outputting the message and the electronic signature to a second external device.

### BRIEF DESCRIPTION OF THE DRAWINGS

FIG. 1 is a block diagram showing a part of a configuration of an example of an electronic signature system.

FIG. 2 is an example block diagram showing the electronic signature system of FIG. 1 performing a verification preparation stage.

FIG. 3 is an example diagram showing the configuration of the Merkle tree of FIG. 2.

FIG. 4 is an example block diagram showing the electronic signature system of FIG. 1 performing the signing stage.

FIG. 5 is an example drawing showing the configuration of the electronic signature of FIG. 4.

FIG. 6 is an example drawing showing some of the components of FIG. 5.

FIG. 7 is an example diagram showing how the verification device verifies the electronic signature of FIG. 5.

FIG. 8 is a flowchart showing an example of an operation sequence of the electronic signature system.

FIG. 9 is an example flowchart showing operation S100 of FIG. 8.

FIG. 10 is an example flowchart showing operation S200 of FIG. 8.

FIG. 11 is an example flowchart showing the operation S250 of FIG. 10.

FIG. 12 is a block diagram showing the configuration of an example of an electronic signature system.

FIG. 13 is an example drawing showing step S100 of FIG. 8 according to the implementation of FIG. 12.

FIG. 14 is an example drawing showing operation S200 of FIG. 8 according to the implementation of FIG. 12.

FIG. 15 is a block diagram showing the configuration of an example of an electronic signature system.

### DETAILED DESCRIPTION

Hereinafter, various implementations will be described in detail and clearly to such an extent that an ordinary one in the art easily implements the present disclosure. Specific details such as detailed components and structures are merely provided to assist the overall understanding of the various implementations. Therefore, it should be apparent to those skilled in the art that various changes and modifications of the implementations described herein may be made without departing from the scope and spirit of the present disclosure. Moreover, descriptions of well-known functions and structures are omitted for clarity and brevity. In the following drawings or in the detailed description, configurations may be connected with any other components except for components illustrated in a drawing or described in the detailed description. The terms described below are terms defined in consideration of the functions of the present disclosure and are not limited to a specific function. The definitions of the terms should be determined based on the contents throughout the specification.

Components that are described in the detailed description with reference to the terms “driver”, “block”, etc. will be implemented with software, hardware, or a combination thereof. For example, the software may be a machine code, firmware, an embedded code, and application software. For example, the hardware may include an electrical circuit, an electronic circuit, a processor, a computer, integrated circuit cores, a pressure sensor, a microelectromechanical system (MEMS), a passive element, or a combination thereof.

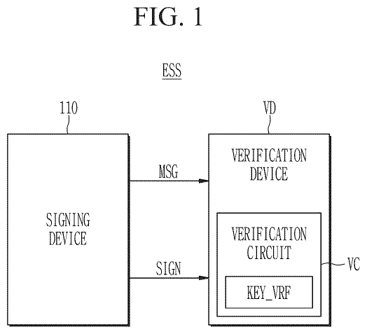

FIG. 1 is a block diagram showing a part of a configuration of an example of an electronic signature system. An electronic signature system ESS may include a signing device 110 and a verification device VD.

The signing device 110 may issue a message MSG, and an electronic signature SIGN corresponding to the message MSG. The verification device VD may receive the message MSG and the electronic signature SIGN.

The verification device VD may include a verification circuit VC. The verification circuit VC may determine whether the message MSG being provided by an authorized user (e.g., an authorized signing device 110), by verifying the electronic signature SIGN based on the verification key KEY_VRF.

When the message MSG is determined to have been provided by authorized user, the verification device VD may normally receive the message MSG. For example, the verification device VD may operate based on the message MSG.

On the other hand, when the message MSG is determined to have been provided an unauthorized user (i.e., the electronic signature SIGN is determined to be forged), the verification device VD may ignore the message MSG.

In some implementations, the verification device VD may be a memory device or a storage device, and the signing device 110 may be a firmware update device. In this case, the verification device VD may provide information related to the firmware update to the verification device VD in a form of the message MSG, and may prove that the user is an authorized user (e.g., proving that the signing device 110 is managed by the vendor of the verification device VD) based on the electronic signature SIGN. On the other hand, the verification device VD may identify whether the message MSG has been provided from authorized user or unauthorized user (e.g., a security attacker for data stored in the verification device) by verifying the electronic signature SIGN. Therefore, the verification device VD may be able to prevent, by verifying the electronic signature SIGN, data leakage due to unauthorized firmware tampering. However, the scope of the present disclosure will not be limited to specific types of the verification device VD and the signing device 110. For example, the verification device VD may be any type of electronic device configured to store data needed to be protected, and the signing device 110 may be any type of electronic device accessing the data stored in the verification device VD.

In some implementations, the signing device 110 may provide the message MSG and the electronic signature SIGN to the verification device VD wired or wirelessly. That is, the scope of the present disclosure is not limited to the type of communication protocol used for transmitting messages MSG and electronic signatures SIGN.

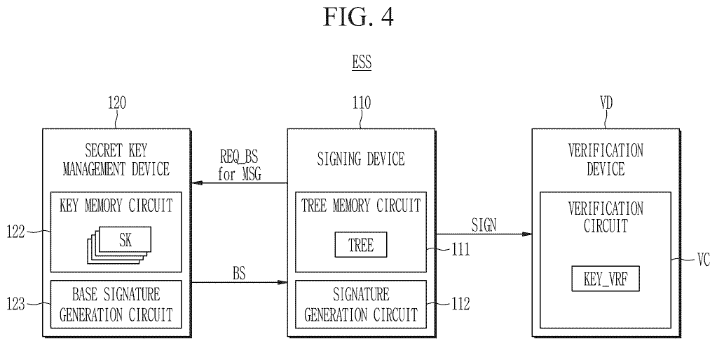

In some implementations, the signing device 110 may issue the message MSG and the electronic signature SIGN at a signing stage. In this case, the signing stage may be performed a plurality of times, and the electronic signature SIGN may be different for each signing stage. The signing stage according to some implementations of the present disclosure will be described in more detail with reference to FIGS. 4 to 7 below.

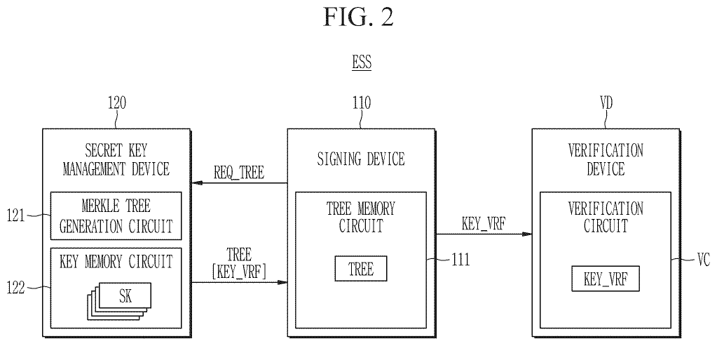

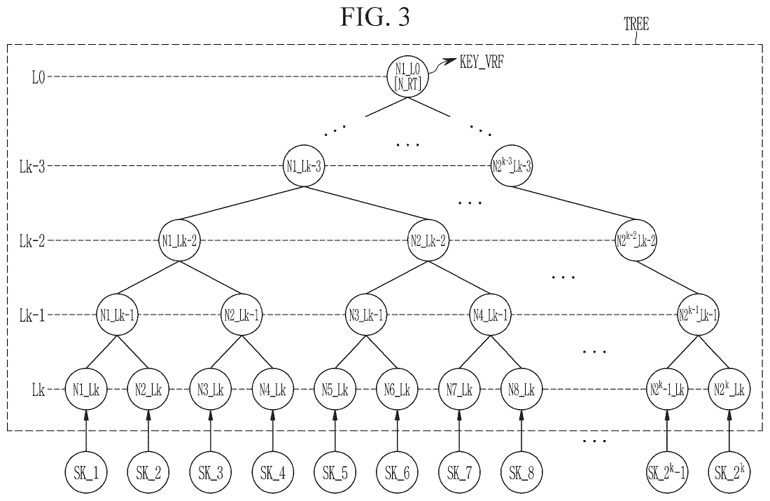

In some implementations, the verification key KEY_VRF may be stored in the verification circuit VC at a verification preparation stage, which is preceding the signing stage. The verification preparation stage according to some implementations of the present disclosure will be described in more detail with reference to FIGS. 2 and 3 below.

FIG. 2 is an example block diagram showing the electronic signature system of FIG. 1 performing a verification preparation stage in more detail. Referring to FIGS. 1 and 2, the electronic signature system ESS may further include a secret key management device 120.

To store a verification key KEY_VRF in the verification circuit VC, the signing device 110 may transmit a Merkle tree request REQ_TREE to the secret key management device 120.

The secret key management device 120 may include a Merkle tree generation circuit 121 and a key memory circuit 122. The key memory circuit 122 may store a plurality of secret keys SK.

In some implementations, the key memory circuit 122 may store a plurality of secret keys SK in a form of hash seed. For example, the key memory circuit 122 may generate the plurality of secret keys SK by hashing each of the plurality of hash seeds. The capacity of each hash seed may be smaller than the capacity of each secret key SK. However, the scope of the present disclosure is not limited to a specific manner in which the plurality of secret keys SK are stored in the key memory circuit 122.

The Merkle tree generation circuit 121 may generate a Merkle tree TREE based on the plurality of secret keys SK in response to the Merkle tree request REQ_TREE. The Merkle tree generation circuit 121 may provide the Merkle tree TREE to the signing device 110. The configuration of the Merkle tree TREE and the operation of the Merkle tree generation circuit 121 will be described in more detail with reference to FIG. 3 below.

In some implementations, the memory space within the secret key management device 120 may be very limited. In this case, it may be difficult for the secret key management device 120 to store the entire Merkle tree generated in the verification preparation stage.

The Merkle tree TREE may include the verification key KEY_VRF. For example, a root node (hereinafter referred to as “N_RT”) of a Merkle tree TREE may include the verification key KEY_VRF. The signing device 110 may provide the verification key KEY_VRF included in the Merkle tree TREE to the verification circuit VC. The verification circuit VC may verify the electronic signature SIGN based on the verification key KEY_VRF at the signing stage.

The signing device 110 may include a tree memory circuit 111. The tree memory circuit 111 may store the Merkle tree TREE provided from the secret key management device 120. The Merkle tree TREE stored in the tree memory circuit 111 may be used to generate the electronic signature SIGN. More specifically, at the signing stage, the signing device 110 may generate the electronic signature SIGN based on the Merkle tree TREE stored in the tree memory circuit 111. The method how the signing device 110 generates the electronic signature SIGN based on the Merkle tree TREE will be described in more detail with reference to FIGS. 4 to 6 below.

That is, according to some implementations of the present disclosure, the secret key management device 120 may output not only the verification key KEY_VRF but also the entire Merkle tree TREE to the verification preparation stage. In this case, since the signing device 110 may store the Merkle tree TREE in advance before the signing stage, the signing device 110 may be able to generate the electronic signature SIGN based on the Merkle tree TREE stored in the tree memory circuit 111 even if the secret key management device 120 does not generate the Merkle tree TREE in the signing stage. Therefore, according to some implementations of the present disclosure, the time taken by the secret key management device 120 to generate a Merkle tree TREE in the signing stage may be reduced, so that the signing device 110 may generate the electronic signature SIGN more quickly.

In some implementations, the configuration of the Merkle tree TREE may not be cryptographically secret. For example, the configuration of the Merkle tree TREE may be independent of the security of a plurality of secret keys SK. That is, even if the Merkle tree TREE is leaked to a security attacker, the security attacker cannot infer the plurality of secret keys SK based on the configuration of the Merkle tree TREE, nor may generate valid electronic signature SIGN. Therefore, according to some implementations of the present disclosure, even if the secret key management device 120 outputs the Merkle tree to the outside (e.g., to the signing device 110), a security vulnerability may not occur.

In some implementations, the secret key management device 120 may be a hardware security module (HSM).

In some implementations, the secret key management device 120 may be located in a physical space only accessible by user of authorized signing device 110. For example, if the verification device VD is a memory device or a storage device and the authorized signing device 110 is a manufacturer of the verification device VD, the secret key management device 120 may be located in a space such as an office building or plant of the manufacturer of the verification device VD. However, the scope of the present disclosure is not limited thereto, and the secret key management device 120 may be located in any type of virtual space, such as a metaverse, virtual reality, etc., which only accessible by user of the authorized signing device 110.

FIG. 3 is an example diagram showing the configuration of the Merkle tree of FIG. 2 in more detail. Referring to FIGS. 1 to 3, the Merkle tree generation circuit 121 may generate the Merkle tree TREE based on the plurality of secret keys SK. In the following, for a more concise explanation, an implementation in which a key memory circuit 122 stores first to 2^{k}-th secret keys (SK_1 to SK_2^{k}) and the Merkle tree generation circuit 121 generates the Merkle tree TREE based on the first to 2^{k}-th secret keys SK_1 to SK_2^{k} will be representatively described.

First, the Merkle tree generation circuit 121 may generate a k-th layer Lk of the Merkle tree TREE based on the first to 2^{k}-th secret keys SK_1 to SK_2^{k}. For example, the Merkle tree generation circuit 121 may generate values of nodes N1_Lk to N2^{k}_Lk included in the k-th layer Lk by hashing (for example, a predetermined number of times) the first to 2^{k}-th secret keys SK_1 to SK_2^{k}. That is, each value of the nodes N1_Lk to N2^{k}_Lk included in the k-th layer Lk may correspond to one secret key SK. In this case, the number of nodes included in the k-th layer Lk may be equal to the number of secret keys SK stored in the key memory circuit 122 (i.e., 2^{k}).

Next, the Merkle tree generation circuit 121 may generate values of nodes N1_Lk-1 to N2^{k-1}_Lk-1 included in the (k−1)-th layer Lk-1 based on nodes N1_Lk to N2^{k}_Lk included in the k-th layer Lk. For example, the Merkle tree generation circuit 121 may generate a value of one of the nodes N1_Lk-1 to N2^{k-1}_Lk-1 included in the (k−1)-th layer Lk-1 based on a combination of two of the nodes N1_Lk to N2^{k}_Lk included in the k-th layer Lk. For a more detailed example, the Merkle tree generation circuit 121 may generate the value of the node N1_Lk-1 based on the combination of the nodes N1_Lk, N2_Lk, and may generate the value of the node N2_Lk-1 based on the combination of the nodes N3_Lk, N4_Lk. In this case, the number of nodes included in the (k−1)-th layer Lk-1 may be half of the number of nodes included in the k-th layer Lk (i.e., 2^{k}).

That is, the Merkle tree generation circuit 121 may generate the value of one node (e.g., a parent node) included in an upper layer based on the values of two nodes (e.g., child nodes) included in a lower layer.

In some implementations, the Merkle tree generation circuit 121 may determine the node value of the upper layer by hashing a combination (e.g., concatenation, summation, etc.) of the hash values of the two nodes included in the lower layer. However, the scope of the present disclosure is not limited to the specific method how the Merkle tree generation circuit 121 determines the node values of the upper layer. For example, the Merkle tree generation circuit 121 may determine the node value of the upper layer by performing any type of operation on two nodes included in the lower layer.

In this way, the Merkle tree generation circuit 121 may generate nodes N1_Lk-2 to N2^{k-2}_Lk-2 included in the (k−2)-th layer Lk-2 based on nodes N1_Lk-1 to N2^{k-1}_Lk-1 included in the (k−1)-th layer Lk-1; and may generate nodes N1_Lk-3 to N2^{k-3}_Lk-3 included in the (k−3)-th layer Lk-3 based on nodes N1_Lk-2 to N2^{k-2}_Lk-2 included in the (k−2)-th layer Lk-2. Finally, the Merkle tree generation circuit 121 may generate a node N1_L0 included in the 0-th layer L0 based on the nodes included in the first layer L1.

That is, the p-th layer Lp of the Merkle tree TREE (where, ‘p’ is an integer greater than or equal to 0 and less than or equal to k) may include 2^{p} nodes, and each of the nodes included in the layers other than the k-th layer Lk may have two child nodes. Therefore, the Merkle tree TREE may be a complete binary tree.

In some implementations, a node N1_L0 included in the 0-th layer L0 may also be referred to as a root node N_RT. That is, the root node N_RT may refer to a node that does not have a parent node.

In some implementations, each of the nodes N1_Lk to N2^{k}_Lk included in the k-th layer may also be referred to as a leaf node. That is, a leaf node may refer to a node that does not have any child node.

In some implementations, the total number of nodes included in the Merkle tree TREE may be 2^{k+1}−1.

In some implementations, two nodes that share one node as a parent node may be referred to as sibling nodes. For example, the parent node of each of node N3_Lk and node N4_Lk may be node N2_Lk-1. In this case, node N3_Lk may be referenced as a sibling node of node N4_Lk, and similarly, node N4_Lk may be referenced as a sibling node of node N3_Lk.

The value of the root node N_RT may be used as a verification key KEY_VRF. That is, in the verification preparation stage, the signing device 110 may provide the value of the root node N_RT of the Merkle tree TREE to the verification device VD as a verification key KEY_VRF.

In some implementations, the number of secret keys SK stored in the key memory circuit 122 may be determined in advance based on the expected number of accesses for the verification device VD of the signing device 110. For example, as the more times the signing device 110 is expected to access the verification device VD, the key memory circuit 122 should store more secret keys SK. In other words, if the signing device 110 is expected to access the verification device VD a lot of times, the number of secret keys SK stored in the key memory circuit 122 may be very large. For example, the number of secret keys SK stored in the key memory circuit 122 may be a very large number, such as 2³⁰ or else.

In some implementations, the greater the number of secret keys SK stored in the key memory circuit 122, the more time taken for the Merkle tree generation circuit 121 to generate the Merkle tree TREE. For example, if the number of secret keys SK stored in the key memory circuit 122 is 2³⁰, the time required for the Merkle tree generation circuit 121 to generate the entire Merkle tree TREE may be several hours or more. However, due to limit of storage space within the secret key management device 120, it may be difficult for secret key management device 120 to store the entire Merkle tree. Accordingly, if the secret key management device 120 is configured to generate the entire Merkle tree TREE whenever the signing device 110 generates the electronic signature SIGN, it may take excessively long time to generate the electronic signature SIGN. However, according to some implementations of the present disclosure, since the signing device 110 may store the Merkle tree TREE, the time required to generate an electronic signature SIGN may be minimized.

FIG. 4 is an example block diagram showing the electronic signature system of FIG. 1 performing the signing stage in more detail. Referring to FIGS. 1 to 4, at the signing stage, the signing device 110 may determine a message MSG to be provided to the verification device VD. For example, the signing device 110 may generate itself or receive from an external device, a message MSG to be provided to the verification device VD.

The signing device 110 may transmit a base signature request REQ_BS for a message MSG to the secret key management device 120.

In some implementations, the signing device 110 may provide the message MSG to the secret key management device 120 together with the base signature request REQ_BS, or may provide the result of hashing the message MSG to the secret key management device 120 together with the base signature request REQ_BS.

The secret key management device 120 may further include a base signature generation circuit 123. The base signature generation circuit 123 may determine one of the plurality of secret keys SK as a target secret key (hereinafter, it may also be referred to as “SK_TG”) in response to the base signature request REQ_BS. The base signature generation circuit 123 may generate a base signature BS based on the target secret key SK_TG. The base signature generation circuit 123 may provide the base signature BS to the signing device 110.

In some implementations, the base signature generation circuit 123 may determine the target secret key SK_TG based on a number of times that the base signature BS has been generated. For example, the base signature generation circuit 123 may manage a count indicating the number of times that the base signature BS has been generated. In this case, the base signature generation circuit 123 may determine a secret key SK which is corresponding to the count value as the target secret key SK_TG. For a more detailed example, when the count value is ‘q’, the base signature generation circuit 123 may determine the (q+1)-th secret key SK_q+1 as the target secret key SK_TG. In this case, the base signature generation circuit 123 may generate a base signature BS corresponding to a different secret key SK whenever it generates the base signature BS. However, the scope of the present disclosure is not limited thereto, and the base signature generation circuit 123 may determine the target secret key SK_TG in any other scheme.

In some implementations, the base signature generation circuit 123 may generate the base signature BS by hashing the target secret key SK_TG. For example, the base signature generation circuit 123 may generate the base signature BS by hashing the target secret key SK_TG a number of times determined based on a hash value of the message MSG. However, the scope of the present disclosure is not limited to the specific algorithm used by the base signature generation circuit 123 to convert the target secret key SK_TG into the base signature BS.

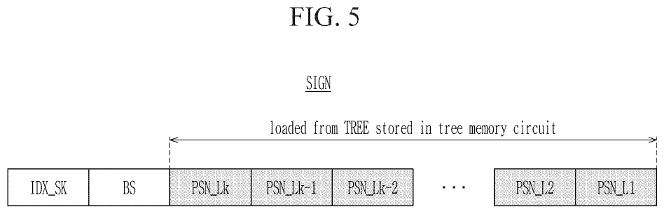

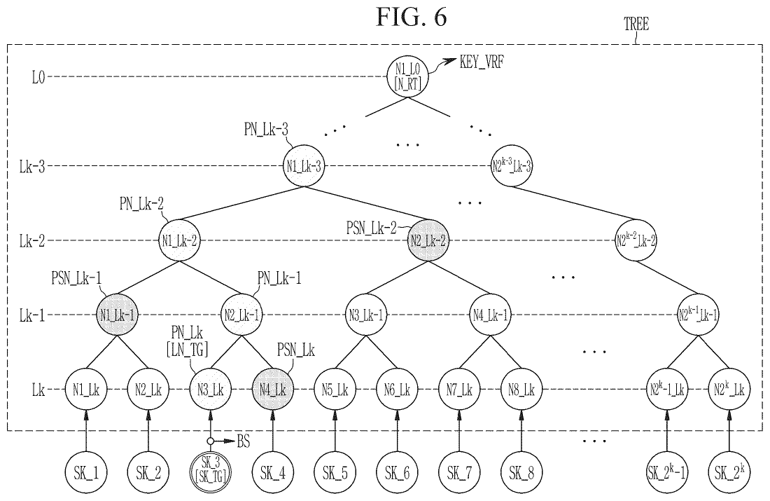

The signing device 110 may further include a signature generation circuit 112. The signature generation circuit 112 may generate an electronic signature SIGN based on the Merkle tree TREE and the base signature BS stored in the tree memory circuit 111. The specific scheme how the signature generation circuit 112 generates the electronic signature SIGN will be described in more detail with reference to FIGS. 5 and 6 below.

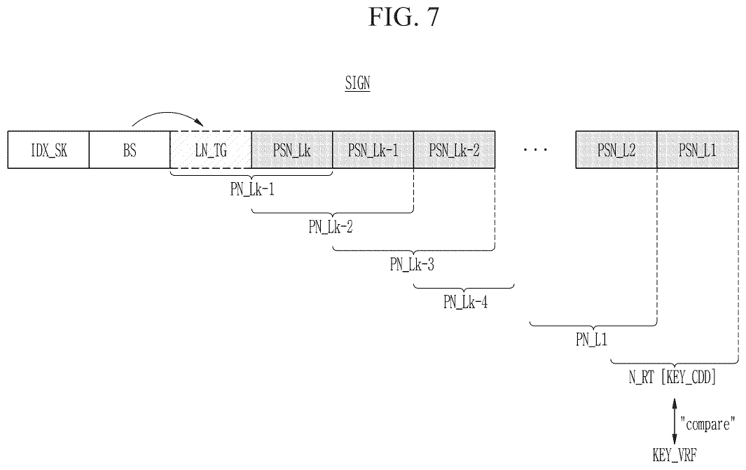

The signing device 110 may provide the electronic signature SIGN to the verification device VD. The verification device VD may verify a validity of the electronic signature SIGN based on the verification circuit VC. For example, the verification circuit VC may verify the validity of the electronic signature SIGN based on a verification key KEY_VRF. The specific scheme how the verification circuit VC verifies the electronic signature SIGN will be described in more detail with reference to FIG. 7 below.

FIG. 5 is an example drawing showing the configuration of the electronic signature of FIG. 4 in more detail. Referring to FIGS. 1 to 5, the signature generation circuit 112 may generate the electronic signature SIGN. The electronic signature SIGN may include a secret key index IDX_SK and the base signature BS.

The secret key index IDX_SK may represent an index of the target secret key SK_TG. For example, if the target secret key SK_TG is a third secret key SK3, the secret key index IDX_SK may be ‘3’.

In some implementations, the secret key index IDX_SK may be provided to the signing device 110 from the base signature generation circuit 123 together with the base signature BS. For example, the base signature generation circuit 123 may provide, to the signature generation circuit 112, together with the base signature BS, the secret key index IDX_SK (e.g., an index corresponding to the target secret key SK_TG) which is determined based on the counter managed by the base signature generation circuit 123. However, the scope of the present disclosure is not limited thereto. For example, the signature generation circuit 112 may count itself the number of times that the base signature request REQ_BS has been issued. In this case, the signature generation circuit 112 may determine the secret key index IDX_SK based on the count.

The electronic signature SIGN may include values of some of the nodes included in the Merkle tree TREE. For example, the electronic signature SIGN may include values of first to k-th path-sibling nodes PSN1 to PSNk for a path from a leaf node (it may be referred to as a target leaf node LN_TG) corresponding to a target secret key SK_TG to a root node N_RT.

The signature generation circuit 112 may load, based on the secret key index IDX_SK, the values of the first to k-th path-sibling nodes PSN1 to PSNk from the Merkle tree TREE stored in the tree memory circuit 111. The specific method how the signature generation circuit 112 identifies the first to k-th path-sibling nodes PSN1 to PSNk will be described with reference to FIG. 6 below.

The signature generation circuit 112 may generate the electronic signature SIGN based on the secret key index IDX_SK, the base signature BS, and the values of the first to k-th path-sibling nodes PSN1 to PSNk. For example, the signature generation circuit 112 may generate an electronic signature SIGN by concatenating the secret key index IDX_SK, the base signature BS, and the values of the first to k-th path-sibling nodes PSN1 to PSNk. However, the scope of the present disclosure is not limited to the type of specific algorithm of which the signature generation circuit 112 generates an electronic signature SIGN based on the secret key index IDX_SK, the base signature BS, and the values of the first to k-th path-sibling nodes PSN1 to PSNk.

In some implementations, the base signature BS may be used to generate the value of the target leaf node LN_TG. For example, each of the value of the base signature BS and the value of the target leaf node LN_TG may be generated by hashing the target secret key SK_TG with different times. In this case, the electronic signature SIGN may not include the value of the target leaf node LN_TG. However, the scope of the present disclosure is not limited thereto. For example, the values of the base signature BS and the target leaf node LN_TG may be generated based on different algorithm applied for the target secret key SK_TG. However, for a brief description, hereinafter, it will be assumed that the value of the target leaf node LN_TG may be generated based on the base signature BS.

FIG. 6 is an example drawing showing some of the components of FIG. 5 in more detail. Referring to FIGS. 1 to 6, the signature generation circuit 112 may identify a target leaf node LN_TG, which is one of the plurality of nodes included in the Merkle tree TREE, based on a secret key index IDX_SK. For a more concise explanation, hereinafter, an implementation in which the signature generation circuit 112 identifies the node N3_Lk as the target leaf node LN_TG based on the secret key index IDX_SK ‘3’ will be representatively described (e.g., it will be assumed that the third secret key SK_3 is the target secret key SK_TG). However, the scope of the present disclosure is not limited thereto, and the signature generation circuit 112 may operate in a similar manner even if the secret key index IDX_SK is a different value.

The signature generation circuit 112 may determine nodes locating on the path from the target leaf node LN_TG to the root node N_RT as path nodes PN. For example, as illustrated in stripe in FIG. 6, the signature generation circuit 112 may identify nodes N3_Lk, N2_Lk-1, N1_Lk-2, N1_Lk-3 as k-th to (k−3)-th path nodes PN_Lk to PN_Lk-3, respectively. In this way, the signature generation circuit 112 may identify one path node PN for each of the first to k-th layers L1 to Lk. In this case, the path nodes included in the first to k-th layers L1 to Lk may be referred to as the first to k-th path nodes PN_L1 to PN_Lk, respectively. The signature generation circuit 112 may also identify the (k−4)-th to first path nodes PN_Lk-4 to PN_L1 in a similar manner.

The signature generation circuit 112 may identify each sibling node of the first to k-th path nodes PN_L1 to PN_Lk as a path-sibling node PSN. For example, the signature generation circuit 112 may identify the sibling nodes of the first to k-th path nodes PN_L1 to PN_Lk as first to k-th path-sibling nodes PSN_L1 to PSN_Lk, respectively. For a more detailed example, as illustrated in the dot pattern in FIG. 6, the signature generation circuit 112 may identify nodes N4_Lk, N1_Lk-1, and N2_Lk-2 as k-th to (k−2)-th path-sibling nodes PSN_Lk to PSN_Lk-2, respectively. In this case, each of the first to k-th path-sibling nodes PSN_L1 to PSN_Lk may be included in different layer each other. For example, the first to k-th path-sibling nodes PSN_L1 to PSN_Lk may be included in the first to k-th layers L1 to Lk, respectively.

The signature generation circuit 112 may load the values of the first to k-th path-sibling nodes PSN_L1 to PSN_Lk from the Merkle tree TREE stored in the tree memory circuit 111. That is, according to some implementations of the present disclosure, instead of requesting the values of the first to k-th path-sibling nodes PSN_L1 to PSN_Lk from the secret key management device 120, the signature generation circuit 112 may load the values of the first to k-th path-sibling nodes PSN_L1 to PSN_Lk from the tree memory circuit 111. In this case, the computational load (or memory space occupancy) of the secret key management device 120 may be minimized; and since unnecessary computations of the signing stage for the Merkle tree TREE which has already been generated in the verification preparation stage may not be performed repeatedly, the operational efficiency of the electronic signature system ESS may be improved.

FIG. 7 is an example diagram showing how the verification device verifies the electronic signature of FIG. 5. The verification circuit VC may receive the message MSG and the electronic signature SIGN. The verification circuit VC may verify the electronic signature SIGN based on the verification key KEY_VRF. For example, the verification circuit VC may determine whether the verification key KEY_VRF can be generated based on the secret key index IDX_SK, the base signature BS, and the first to k-th path-sibling nodes PSN1 to PSNk included in the electronic signature SIGN.

First, the verification circuit VC may identify the location of the target leaf node LN_TG within the Merkle tree TREE based on the secret key index IDX_SK. That is, since the Merkle tree TREE is a complete binary tree, even if the verification circuit VC does not know the values of each node of the Merkle tree TREE, the verification circuit VC may be able to identify the path from the target leaf node LN_TG to the root node N_RT within the Merkle tree TREE based on the secret key index IDX_SK.

The verification circuit VC may generate the value of the target leaf node LN_TG based on the base signature BS. For example, the verification circuit VC may convert the base signature BS into a value of the target leaf node LN_TG based on the message MSG. For a more detailed example, the verification circuit VC may identify, based on the message MSG, a first value indicating the number of times that hashing has been performed on the target secret key SK_TG to generate the base signature BS. In some implementations, the first value may be determined based on a hash value of the message MSG. The verification circuit VC may identify a second value indicating the number of times that needed to be hashed on the target secret key SK_TG to generate the value of the target leaf node LN_TG. In some implementations, the second value may be shared between the secret key management device 120 and the verification device VD during or before the verification preparation stage. The verification circuit VC may generate the value of the target leaf node LN_TG by hashing the base signature BS with a times determined by subtracting the first value from the second value. However, the scope of the present disclosure is not limited to the specific relationship between the values of the target secret key SK_TG, the base signature BS, and the target leaf node LN_TG.

The verification circuit VC may generate a candidate key KEY_CDD based on the value of the target leaf node LN_TG and the values of the first to k-th path-sibling nodes PSN_L1˜PSN_Lk. For example, the verification circuit VC may generate the candidate key KEY_CDD by sequentially combining the value of the target leaf node LN_TG with the values of k-th to first path-sibling nodes PSN_Lk˜PSN_L1. More specifically, the verification circuit VC may generate a value of the (k−1)-th path node PN_Lk-1 by hashing a result of concatenating a hash value of the target leaf node LN_TG and a hash value of the k-th path-sibling node PSN_Lk; and may generate a hash value of the (k−2)-th path node PN_Lk-2 by hashing a result of concatenating a hash value of the (k−1)-th path node PN_Lk-1 and a hash value of the (k−1)-th path-sibling node PSN_Lk-1. In this way, the verification circuit VC may generate the value of the root node N_RT by hashing a result of concatenating the hash value of the first path node PN_L1 and the hash value of the first path-sibling node PSN_L1. That is, the verification circuit VC may generate values of some nodes of the Merkle tree TREE in a similar manner to the Merkle tree generation circuit 121.

In some implementations, the verification circuit VC and the Merkle tree generation circuit 121 may perform hash operations based on the same hash algorithm. For example, the verification circuit VC and the Merkle tree generation circuit 121 may share one of any type of hash algorithm, such as SHA-256, Whirlpool, Tiger, etc.

The verification circuit VC may determine the value of the generated root node N_RT as the candidate key KEY_CDD. The verification circuit VC may determine whether the electronic signature SIGN has been forged by comparing the candidate key KEY_CDD and the verification key KEY_VRF.

If the candidate key KEY_CDD and the verification key KEY_VRF are identical, the verification circuit VC may determine that the electronic signature SIGN is valid (i.e., provided by an authorized user). In this case, the verification device VD may validly receive the message MSG. For example, the verification device VD may operate in response to what the message MSG indicates.

On the other hand, if the candidate key KEY_CDD and the verification key KEY_VRF are different, the verification circuit VC may determine that the electronic signature SIGN is invalid (i.e., a forged electronic signature SIGN). In this case, the verification device VD may ignore the message MSG. For example, the verification device VD may not operate in response to what a message MSG indicates. In this case, access to the verification device VD from unauthorized users may be blocked.

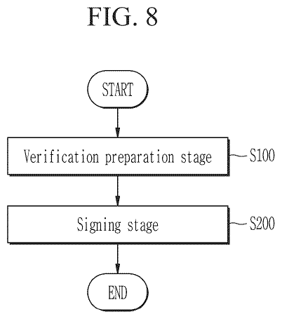

FIG. 8 is a flowchart showing an example of an operation sequence of the electronic signature system. Referring to FIGS. 1 to 8, at operation S100, the electronic signature system ESS may perform a verification preparation stage. For example, similarly to which described above with reference to FIGS. 2 and 3, the signing device 110 may control the secret key management device 120 to provide the generated verification key KEY_VRF to the verification device VD.

At operation S200, the electronic signature system ESS may perform the signing stage. For example, similarly to which described above with reference to FIGS. 4 to 7, the signing device 110 may provide the electronic signature SIGN to the verification device VD, and the verification device VD may verify the electronic signature SIGN based on a verification key KEY_VRF.

In some implementations, the electronic signature system ESS may perform operation S100 only once during the production stage of the verification device VD. On the other hand, after the operation S100 is performed, the electronic signature system ESS may repeatedly perform the operation S200. For example, when updating firmware of the verification device VD, the electronic signature system ESS may perform the operation S200 repeatedly. However, the scope of the present disclosure is not limited to the specific case where the electronic signature system ESS performs the operation S200.

In some implementations, the electronic signature system ESS may change the target secret key SK_TG whenever it performs the operation S200. In this case, the secret key index IDX_SK may be increased by ‘1’ each time the operation S200 is performed. However, the verification device VD may verify, based on only one verification key KEY_VRF, a plurality of electronic signatures SIGN generated based on different target secret keys SK_TG. That is, the verification device VD may verify all the electronic signatures SIGN for cases where each of the first to 2^{k}-th secret keys SK_1 to SK_2^{k} is a target secret key SK_TG based on one verification key KEY_VRF.

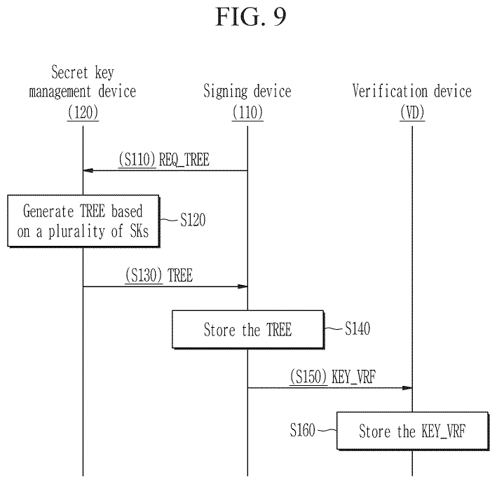

FIG. 9 is an example flowchart showing operation S100 of FIG. 8 in more detail. Referring to FIGS. 1 to 9, operation S100 may include operations S110 to S160.

At operation S110, the signing device 110 may transmit a Merkle tree request REQ_TREE to the secret key management device 120.

At operation S120, the secret key management device 120 may generate a Merkle tree TREE based on a plurality of secret keys SK in response to a Merkle tree request REQ_TREE. For example, in a similar manner to that described above with reference to FIG. 3, the Merkle tree generation circuit 121 may generate a Merkle tree TREE based on a plurality of secret keys SK stored in the key memory circuit 122.

At operation S130, the secret key management device 120 may provide the Merkle tree TREE to the signing device 110. The Merkle tree TREE may include a verification key KEY_VRF.

At operation S140, the signing device 110 may store the Merkle tree TREE. For example, the signing device 110 may store the Merkle tree TREE in the tree memory circuit 111. The Merkle tree TREE stored in the tree memory circuit 111 may be used when the operation S200 is performed.

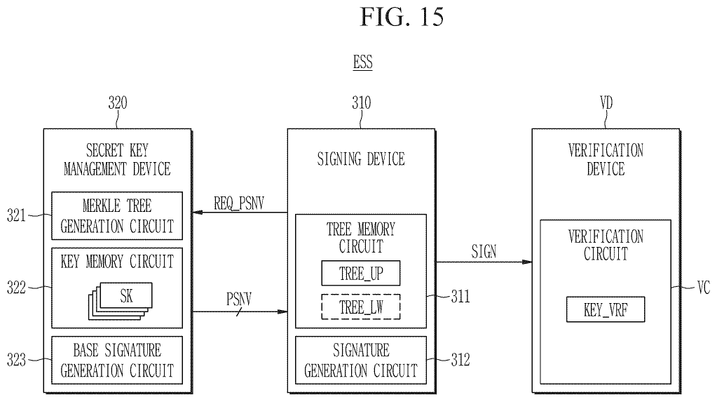

In some implementations, the signing device 110 may store only a portion of the Merkle tree TREE. An implementation in which the signing device 110 stores only a portion of the Merkle tree will be described in more detail with reference to FIG. 15 below.

In some implementations, unlike that illustrated in FIG. 9, operation S140 may be performed after operation S150 or operation S160. That is, the scope of the present disclosure is not limited to the specific order where the operation S140 is performed.

At operation S150, the signing device 110 may provide the verification key KEY_VRF to the verification device VD. For example, the signing device 110 may provide the value of the root node N_RT of the Merkle tree TREE as the verification key KEY_VRF to the verification device VD.

At operation S160, the verification device VD may store the verification key KEY_VRF. For example, the verification circuit VC may store the verification key KEY_VRF. The verification key KEY_VRF may be used when the operation S200 is performed.

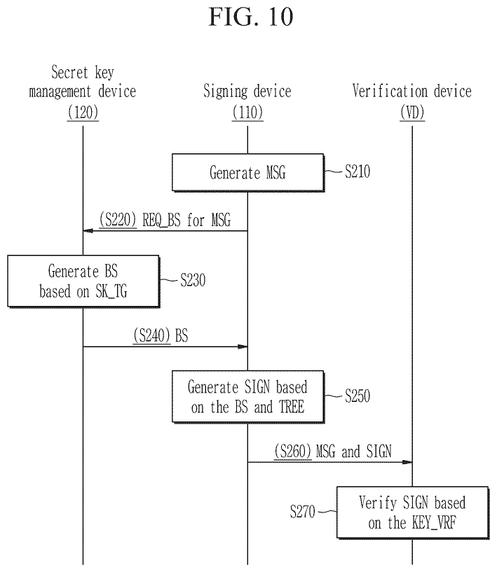

FIG. 10 is an example flowchart showing operation S200 of FIG. 8 in more detail. Referring to FIGS. 1 to 10, operation S200 may include operations S210 to S270.

At operation S210, the signing device 110 may generate a message MSG to be provided to the verification device VD.

At operation S220, the signing device 110 may transmit a base signature request REQ_BS for the message MSG to the secret key management device 120. For example, the signing device 110 may transmit the message MSG together with the base signature request REQ_BS to the secret key management device 120, or may transmit a hash value of the message MSG together with the base signature request REQ_BS to the secret key management device 120.

At operation S230, the secret key management device 120 may generate the base signature BS based on the target secret key SK_TG. For example, the base signature generation circuit 123 may determine the target secret key SK_TG based on the total number of times the base signature BS has been generated. The base signature generation circuit 123 may generate the base signature BS by hashing the target secret key SK_TG with number of times determined based on the hash value of the message MSG. However, the scope of the present disclosure is not limited to a specific algorithm how the base signature generation circuit 123 generates the base signature BS.

At operation S240, the secret key management device 120 may transmit the base signature BS to the signing device 110.

In some implementations, the secret key management device 120 may transmit a secret key index IDX_SK indicating the target secret key SK_TG to the signing device 110 together with the base signature BS. However, the scope of the present disclosure is not limited thereto.

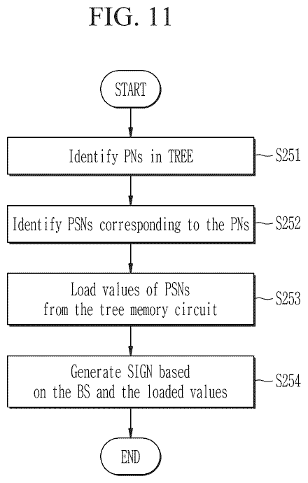

At operation S250, the signing device 110 may generate an electronic signature SIGN based on the base signature BS and the Merkle tree TREE, in a similar manner as described above with reference to FIGS. 5 and 6. The operation S250 will be described in more detail with reference to FIG. 11 below.

At operation S260, the signing device 110 may transmit the message MSG and the electronic signature SIGN to the verification device VD.

At operation S270, in a similar manner as described above with reference to FIG. 7, the verification device VD may verify the electronic signature SIGN based on the verification key KEY_VRF. For example, the verification device VD may verify the electronic signature SIGN based on the verification key KEY_VRF stored in a verification circuit VC, and the message MSG.

FIG. 11 is an example flowchart showing the operation S250 of FIG. 10 in more detail. Referring to the FIGS. 1 to 11, the operation S250 may include operations S251 to S254 below.

At operation S251, the signing device 110 may identify a plurality of path nodes PN. For example, the signature generation circuit 112 may identify a plurality of path nodes PN located on a path in the Merkle tree TREE from a target leaf node LN_TG to a root node N_RT. That is, the signature generation circuit 112 may identify the first to k-th path nodes PN1 to PNk based on the secret key index SK_IDX.

At operation S252, the signing device 110 may identify a plurality of path-sibling nodes PSN corresponding to the plurality of path nodes PN. For example, the signature generation circuit 112 may identify each sibling node of the plurality of path nodes PN as a path-sibling node PSN. That is, the signature generation circuit 112 may identify the sibling nodes of the first to k-th path nodes PN1 to PNk as the first to k-th path-sibling nodes PSN1 to PSNk, respectively.

At operation S253, the signing device 110 may load values of a plurality of path-sibling nodes PSN from the tree memory circuit 111. For example, the signature generation circuit 112 may load the values of the first to k-th path-sibling nodes PSN1 to PSNk from the Merkle tree TREE stored in the tree memory circuit 111.

In some implementations, only a portion of a Merkle tree TREE may be stored in the tree memory circuit 111. In this case, the signature generation circuit 112 may be able to load from the tree memory circuit 111, among the first to k-th path-sibling nodes PSN1 to PSNk, only the values of the path-sibling nodes included in the Merkle tree TREE stored in the tree memory circuit 111. In this case, the signature generation circuit 112 may request the values of path-sibling nodes that cannot be loaded from the tree memory circuit 111 (e.g., values of path-sibling nodes included in the other part of the Merkle tree TREE, which is not stored in the tree memory circuit 111) to the secret key management device 120. An implementation in which only a part of a Merkle tree TREE is stored in the tree memory circuit 111 will be described with reference to FIG. 15 below.

At operation S254, the signing device 110 may generate the electronic signature SIGN based on the loaded values and the base signature BS. For example, the signature generation circuit 112 may generate the electronic signature SIGN based on the base signature BS received in operation S240 and the values of the plurality of path-sibling nodes PSN loaded in operation S253.

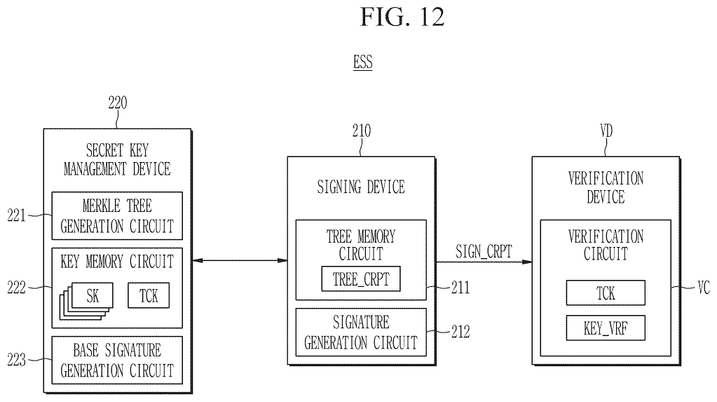

FIG. 12 is a block diagram showing the configuration of an example of an electronic signature system. Referring to FIGS. 1 to 12, an electronic signature system ESS may include a signing device 210, a secret key management device 220, and a verification device VD. The signing device 210 may include a tree memory circuit 211 and a signature generation circuit 212. The secret key management device 220 may include a Merkle tree generation circuit 221, a key memory circuit 222, and a base signature generation circuit 223.

The components of the signing device 210 may perform functions and operations similar to those of the components of the signing device 110 described above with reference to FIGS. 1 to 10, and the components of the secret key management device 220 may perform functions and operations similar to those of the components of the secret key management device 120 described above with reference to FIGS. 1 to 10. Hereinafter, the differences between the signing device 110 and the signing device 210, and the differences between the secret key management device 120 and the secret key management device 220 will be mainly described.

The secret key management device 220 and the verification device VD may share a tree cryptographic key TCK. For example, the key memory circuit 222 and the verification circuit VC may store a tree cryptographic key TCK.

In some implementations, the tree cryptographic key TCK may be generated from the secret key management device 220. In this case, the signing device 210 may provide, to the verification device VD, the tree cryptographic key TCK which is provided from the secret key management device 220.

In some implementations, the tree cryptographic key TCK may be generated from the signing device 210. In this case, the signing device 210 may provide the tree cryptographic key TCK to both of the secret key management device 220 and the verification device VD.

In some implementations, the signing device 210 may discard the tree cryptographic key TCK after providing the tree cryptographic key TCK to the verification device VD. That is, the signing device 210 may not store the tree cryptographic key TCK. In this case, the tree cryptographic key TCK may only be shared by the verification device VD and the secret key management device 220.

In the verification preparation stage, the Merkle tree generation circuit 221 may generate a Merkle tree TREE based on a plurality of secret keys SK stored in the key memory circuit 222. The Merkle tree generation circuit 221 may generate an encrypted Merkle tree TREE_CRPT by encrypting the Merkle tree TREE based on the tree cryptographic key TCK stored in the key memory circuit 222. The Merkle tree generation circuit 221 may provide the encrypted Merkle tree TREE_CRPT to the signing device 210. In other words, the Merkle tree generation circuit 221 may provide the Merkle tree TREE to the signing device 210 in an encrypted form based on the tree cryptographic key TCK. In this case, the tree memory circuit 211 may store the encrypted Merkle tree TREE_CRPT instead of the Merkle tree TREE.

In some implementations, the Merkle tree generation circuit 221 may generate the encrypted Merkle tree TREE_CRPT by encrypting the values of each of a plurality of nodes included in the Merkle tree TREE, based on the tree cryptographic key TCK. For example, the Merkle tree generation circuit 221 may generate the encrypted Merkle tree TREE_CRPT by encrypting the values of a plurality of nodes, other than the root node N_RT, included in the Merkle tree TREE.

At the signing stage, the signature generation circuit 212 may generate an encrypted electronic signature SIGN_CRPT based on the encrypted Merkle tree TREE_CRPT. The encrypted electronic signature SIGN_CRPT may correspond to encrypted form of the electronic signature SIGN described above with reference to FIG. 5, where the values of the path-sibling nodes PSN are encrypted. In other words, the signature generation circuit 212 may generate an electronic signature SIGN in encrypted form based on the tree cryptographic key TCK.

The verification circuit VC may verify the encrypted electronic signature SIGN_CRPT based on the verification key KEY_VRF and the tree cryptographic key TCK. In other words, the signature generation circuit 212 may verify the electronic signature SIGN which has an encrypted form, based on the tree cryptographic key TCK. For example, the verification circuit VC may convert the encrypted electronic signature SIGN_CRPT into the electronic signature SIGN as described above with reference to FIG. 5, based on the tree cryptographic key TCK. In this case, the verification circuit VC may be able to verify the electronic signature SIGN based on the verification key KEY_VRF, similar to what was described above with reference to FIG. 7.

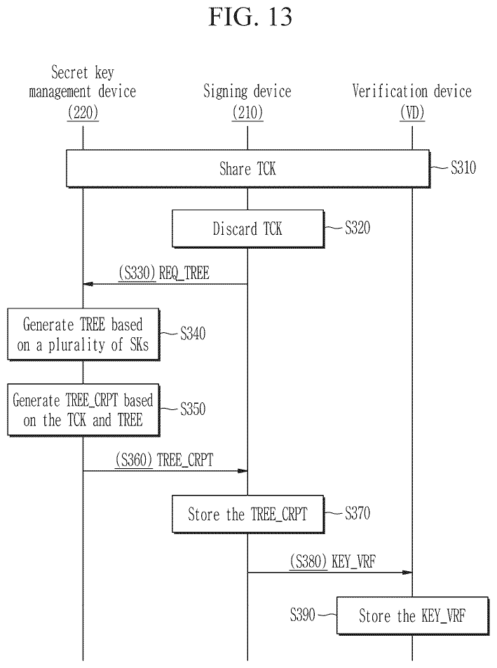

FIG. 13 is an example drawing showing step S100 of FIG. 8 in more detail according to the implementation of FIG. 12. Referring to FIGS. 1 to 13, operation S100 may include operations S310 to S390 below.

At operation S310, the electronic signature system ESS may share a tree encryption key TCK. For example, the signing device 210 may provide the tree cryptographic key TCK generated from the secret key management device 220 to the verification device VD. Alternatively, the signing device 210 may generate the tree cryptographic key TCK, and then provide the tree cryptographic key TCK to both of the secret key management device 220 and the verification device VD.

At operation S320, the signing device 210 may discard the tree cryptographic key TCK. For example, the signing device 210 may not store the tree encryption key TCK anymore. In this case, the tree cryptographic key TCK will only be shared by the secret key management device 220 and the verification device VD.

At operation S330, the signing device 210 may transmit a Merkle tree request REQ_TREE to the secret key management device 220. At operation S340, the secret key management device 220 may generate a Merkle tree TREE based on a plurality of secret keys SK in response to the Merkle tree request REQ_TREE. Since operations S330 to S340 are similar to operations S110 to S120, so a detailed description will be omitted.

At operation S350, the secret key management device 220 may generate an encrypted Merkle tree TREE_CRPT based on the tree cryptographic key TCK and the Merkle tree TREE. For example, the secret key management device 220 may generate an encrypted Merkle tree TREE_CRPT by encrypting each value of nodes included in the first to k-th layers L1 to Lk of the Merkle tree TREE based on the tree cryptographic key TCK.

In some implementations, the secret key management device 220 may not encrypt the root node N_RT of the Merkle tree TREE. In this case, the root node of the encrypted Merkle tree TREE_CRPT may correspond to the verification key KEY_VRF. However, the scope of the present disclosure is not limited thereto, and the secret key management device 220 may also encrypt the entire Merkle tree TREE including the root node N_RT.

At operation S360, the secret key management device 220 may provide the encrypted Merkle tree TREE_CRPT to the signing device 110. At operation S370, the signing device 210 may store the encrypted Merkle tree TREE_CRPT. For example, the tree memory circuit 211 may store an encrypted Merkle tree TREE_CRPT instead of the Merkle tree TREE.

That is, according to some implementations of the present disclosure, the encrypted Merkle tree TREE_CRPT may be stored in the signing device 210. In this case, since the signing device 210 has discarded the tree cryptographic key TCK, the signing device 210 cannot decrypt the encrypted Merkle tree TREE_CRPT, so the security of the electronic signature system ESS may be improved.

At operation S380, the signing device 210 may provide a verification key KEY_VRF to the verification device VD. At operation S390, the verification device VD may store the verification key KEY_VRF. Since operations S380 to S390 are similar to operations S150 to S160, so a detailed description will be omitted.

In some implementations, if the secret key management device 220 is implemented to encrypt the entire Merkle tree TREE including the root node N_RT based on the tree cryptographic key TCK, the signing device 210 may transmit the verification key KEY_VRF in encrypted form to the verification device VD at operation S380. In this case, the verification device VD may be able to decrypt the verification key KEY_VRF based on the tree cryptographic key TCK. However, the scope of the present disclosure is not limited thereto.

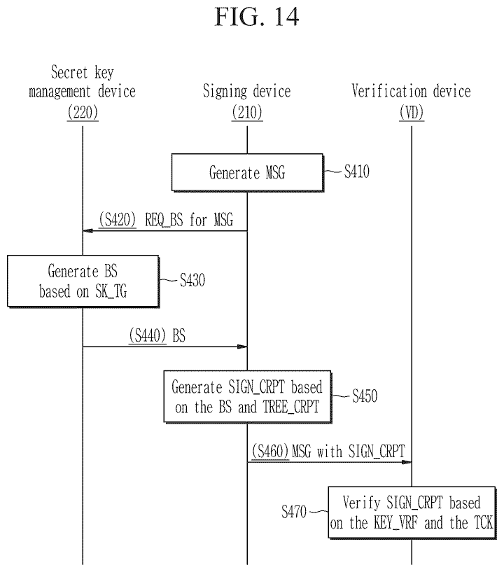

FIG. 14 is an example drawing showing operation S200 of FIG. 8 in more detail according to the implementation of FIG. 12. Referring to FIGS. 1 to 14, the operation S200 may include operations S410 to S470 below.

At operation S410, the signing device 210 may generate a message MSG to be provided to the verification device VD. At operation S420, the signing device 210 may transmit a base signature request REQ_BS for the message MSG to the secret key management device 220. At operation S430, the secret key management device 220 may generate a base signature BS based on the target secret key SK_TG. At operation S440, the secret key management device 220 may transmit the base signature BS to the signing device 210. Since operations S410 to S440 are similar to operations S210 to S240, so a detailed description will be omitted.

At operation S450, the signing device 210 may generate an encrypted electronic signature SIGN_CRPT based on the base signature BS and the encrypted Merkle tree TREE_CRPT. The encrypted electronic signature SIGN_CRPT may correspond to a result obtained by encrypting each of the values of a plurality of path-sibling nodes PSN of the electronic signature SIGN described above with reference to FIG. 6 based on a tree cryptographic key TCK.

At operation S460, the signing device 210 may transmit the message MSG and the encrypted electronic signature SIGN_CRPT to the verification device VD.

At operation S470, the verification device VD may verify the encrypted electronic signature SIGN_CRPT based on the verification key KEY_VRF and the tree cryptographic key TCK. For example, a verification circuit VC may decrypt the encrypted electronic signature SIGN_CRPT based on the tree encryption key TCK. Thereafter, the verification circuit VC may verify the encrypted electronic signature SIGN_CRPT based on the verification key KEY_VRF, similarly to what was described above with reference to FIG. 7.

FIG. 15 is a block diagram showing the configuration of an example of an electronic signature system. Referring to FIGS. 1 to 10 and 15, an electronic signature system ESS may include a signing device 310, a secret key management device 320, and a verification device VD. The signing device 310 may include a tree memory circuit 311 and a signature generation circuit 312. The secret key management device 320 may include a Merkle tree generation circuit 321, a key memory circuit 322, and a base signature generation circuit 323.

The components of the signing device 310 may perform functions and operations similar to those of the components of the signing device 310 described with reference to FIGS. 1 to 10 above, and the components of the secret key management device 320 may perform functions and operations similar to those of the components of the secret key management device 320 described with reference to FIGS. 1 to 10 above. Hereinafter, the differences between the signing device 110 and the signing device 310, and the differences between the secret key management device 120 and the secret key management device 320 will be mainly described.

In the verification preparation stage, the tree memory circuit 311 may store an upper Merkle tree TREE_UP. For example, in the verification preparation stage, the Merkle tree generation circuit 321 may generate a Merkle tree TREE. The Merkle tree generation circuit 321 may provide the upper Merkle tree TREE_UP, which is a part of the Merkle tree TREE, to the tree memory circuit 311. In this case, the tree memory circuit 311 may store only the upper Merkle tree TREE_UP instead of storing the entire Merkle tree TREE. In other words, the tree memory circuit 311 may not store a lower Merkle tree TREE_LW corresponding to the remainder of the Merkle tree TREE excluding the upper Merkle tree TREE_UP.

In some implementations, the upper Merkle tree TREE_UP may be implemented as upper layers of the Merkle tree TREE. For example, the upper Merkle tree TREE_UP may include first to t-th layers L0 to Lt. (Wherein, ‘t’ may be an integer greater than or equal to 0 and less than or equal to k.)

In some implementations, the lower Merkle tree TREE_LW may be implemented as lower layers of the Merkle tree TREE. For example, the lower Merkle tree TREE_LW may include the (t+1)-th to k-th layers Lt+1 to Lk.

At the signing stage, the signing device 310 may generate an electronic signature SIGN based on the upper Merkle tree TREE_UP stored in the tree memory circuit 311. For example, the signature generation circuit 312 may load some of the values of the first to k-th path-sibling nodes PSN1 to PSNk from the upper Merkle tree TREE_UP. More specifically, the signature generation circuit 312 may retrieve the values of the first to t-th path-sibling nodes PSN1 to PSNt from the upper Merkle tree TREE_UP.

The signing device 310 may request the secret key management device 320 for the values of path-sibling nodes that are not included in the upper Merkle tree TREE_UP among the first to k-th path-sibling nodes PSN1 to PSNk (e.g., the values of path-sibling nodes included in the lower Merkle tree TREE_LW). For example, the signing device 310 may transmit a path-sibling node value request REQ_PSNV for the values of the (t+1)-th to k-th path-sibling nodes PSNt+1 to PSNk to the secret key management device 320.

The Merkle tree generation circuit 321 may generate path-sibling node values PSNV for the (t+1)-th to k-th path-sibling nodes PSNt+1 to PSNk in response to the path-sibling node value request REQ_PSNV. For example, the Merkle tree generation circuit 321 may generate at least a portion of the lower Merkle tree TREE_LW in response to the path-sibling node value request REQ_PSNV. Thereafter, the Merkle tree generation circuit 321 may provide path-sibling node values PSNV for the (t+1)-th to k-th path-sibling nodes PSNt+1 to PSNk to the signing device 310.

The signature generation circuit 312 may generate an electronic signature SIGN based on a secret key index IDX_SK, a base signature BS, values of the first to t-th path-sibling nodes PSN1 to PSNt loaded from an upper Merkle tree TREE_UP, and path-sibling node values PSNV provided from the Merkle tree generation circuit 321.

That is, according to some implementations of the present disclosure, as the larger the size (e.g., height) of the upper Merkle tree TREE_UP stored in the tree memory circuit 311 in the verification preparation stage, the computational load of the secret key management device 320 for generating the lower Merkle tree TREE_LW in the signing stage may be reduced. Conversely, as the smaller the size (e.g., height) of the upper Merkle tree TREE_UP stored in the tree memory circuit 311 in the verification preparation stage, the capacity of the tree memory circuit 311 may be implemented with smaller size.

In some implementations, the size of the upper Merkle tree TREE_UP stored in the tree memory circuit 311 in the verification preparation stage may be inversely proportional to the time taken by the Merkle tree generation circuit 321 for generating the path-sibling node values PSNV in the signing stage. For example, when the size of the upper Merkle tree TREE_UP stored in the tree memory circuit 311 in the verification preparation stage doubles, the time taken by the Merkle tree generation circuit 321 for generating the path-sibling node values PSNV in the signing stage may be approximately halved. However, the scope of the present disclosure is not limited thereto.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to implementations thereof, it will be apparent to those of ordinary skill in the art that various changes and modifications may be made thereto without departing from the spirit and scope of the present disclosure as set forth in the following claims.

What is claimed is:

1. An electronic signature system comprising:
a secret key management device configured to output a Merkle tree generated based on a plurality of secret keys and to output a base signature generated based on a target secret key which is one of the plurality of secret keys; and
a signing device configured to generate an electronic signature based on the Merkle tree and the base signature, the electronic signature corresponding to the target secret key.

2. The electronic signature system of claim 1, comprising a verification device configured to:
receive, from the signing device, a verification key included in the Merkle tree; and
verify the electronic signature based on the verification key.

3. The electronic signature system of claim 2, wherein the signing device comprises:
a tree memory circuit configured to store the Merkle tree; and
a signature generation circuit configured to generate the electronic signature based on the Merkle tree and the base signature.

4. The electronic signature system of claim 3, wherein the signature generation circuit is configured to:
identify a plurality of path nodes on a first path from a leaf node to a root node within the Merkle tree, the leaf node corresponding to the target secret key;
identify a plurality of path-sibling nodes corresponding to the plurality of path nodes, respectively; and
generate the electronic signature based on the base signature and a plurality of values of the plurality of path-sibling nodes.

5. The electronic signature system of claim 4, wherein the verification device is configured to:
generate a candidate key based on the base signature and the plurality of values of the plurality of path-sibling nodes included in the electronic signature; and
verify the electronic signature based on a comparison of the candidate key with the verification key.

6. The electronic signature system of claim 5, wherein:
the signing device is configured to generate a message;
the secret key management device is configured to generate the base signature based on the target secret key and the message; and
the verification device is configured to verify the electronic signature based on the candidate key, the verification key, and the message.

7. The electronic signature system of claim 2, wherein:
the secret key management device and the verification device are configured to share a tree encryption key;
the secret key management device is configured to output the Merkle tree in a first encrypted form based on the tree encryption key;
the signing device is configured to generate the electronic signature in a second encrypted form based on the Merkle tree in the first encrypted form and the base signature; and
the verification device is configured to verify the electronic signature based on the tree encryption key and the verification key.

8. The electronic signature system of claim 1, wherein the secret key management device is configured to determine the target secret key based on a number of times the base signature is generated.

9. The electronic signature system of claim 1, wherein:
the secret key management device is a hardware security module (HSM).

10. An electronic signature system comprising:
a secret key management device including
a secret key memory circuit configured to manage first to 2^{k}-th secret keys and
a Merkle tree generation circuit configured to generate a Merkle tree based on the first to 2^{k}-th secret keys, wherein k is an integer greater than or equal to 1;
a signing device including
a tree memory circuit configured to store an upper Merkle tree which is a part of the Merkle tree in a verification preparation stage, and
a signature generation circuit configured to generate a first electronic signature based on the upper Merkle tree in a first signing stage after the verification preparation stage; and
a verification device configured to verify the first electronic signature in the first signing stage.

11. The electronic signature system of claim 10, wherein:
in the verification preparation stage, the signing device is configured to provide a verification key to the verification device, the verification key corresponding to a root node of the Merkle tree; and
in the first signing stage, the verification device is configured to verify the first electronic signature based on the verification key.

12. The electronic signature system of claim 11, wherein:
a k-th layer of the Merkle tree includes first to 2^{k}-th leaf nodes corresponding to the first to 2^{k}-th secret keys, respectively;
a 0-th layer of the Merkle tree includes the root node; and
the signature generation circuit is configured to generate the first electronic signature based on a plurality of values of a first plurality of path-sibling nodes respectively corresponding to a first plurality of path nodes located on a first path in the Merkle tree from the first leaf node to the root node.

13. The electronic signature system of claim 12, wherein the signature generation circuit is configured to load some of the plurality of values of the first plurality of path-sibling nodes from the upper Merkle tree stored in the tree memory circuit.

14. The electronic signature system of claim 13, wherein the signature generation circuit is configured to receive, in the first signing stage from the secret key management device, a plurality of values of a second plurality of path-sibling nodes among the first plurality of path-sibling nodes, the second plurality of path-sibling nodes being outside the upper Merkle tree.

15. The electronic signature system of claim 13, wherein the upper Merkle tree comprises a plurality of upper t-layers of the Merkle tree, wherein t is greater than or equal to 2 and less than or equal to k+1.

16. The electronic signature system of claim 12, wherein:
in a second signing stage after the first signing stage, the signature generation circuit is configured to generate a second electronic signature based on a plurality of values of a third plurality of path-sibling nodes respectively corresponding to a second plurality of path nodes located on a second path in the Merkle tree from the second leaf node to the root node; and
in the second signing stage, the verification device is configured to verify the second electronic signature based on the verification key.

17. The electronic signature system of claim 12, wherein:
the secret key management device is configured to provide, in the first signing stage, a first base signature to the signing device, the first base signature being generated based on the first secret key; and
the signing device is configured to generate the first electronic signature based on the first base signature.

18. The electronic signature system of claim 17, wherein, in the first signing stage:
the signing device is configured to generate a first message;
the secret key management device is configured to generate the first base signature corresponding to the first message;
the signing device is configured to provide the first message and the first electronic signature to the verification device; and
the verification device is configured to verify the first electronic signature based on the first message.

19. An operation method of a signing device comprising:
receiving, from a first external device, a Merkle tree generated based on a plurality of secret keys;
generating a message;
receiving, from the first external device, a base signature generated based on the message and a target secret key of the plurality of secret keys;
generating an electronic signature based on the Merkle tree and the base signature; and
outputting the message and the electronic signature to a second external device.

20. The operation method of claim 19, wherein generating the electronic signature comprises:
identifying a plurality of path nodes located on a path from a leaf node to a root node within the Merkle tree, the leaf node corresponding to the target secret key;
identifying a plurality of path-sibling nodes corresponding to the plurality of path nodes, respectively;
loading a plurality of values of the plurality of path-sibling nodes; and
generating the electronic signature based on the plurality of values of the plurality of path-sibling nodes and the base signature.
